(19) United States
(12) Patent Application Publication
(10) Pub. No.: US 2024/0168224 A1
(43) Pub. Date: May 23, 2024

(54) Optical Bandsplitter

(71) Applicant: Telefonaktiebolaget LM Ericsson (publ), Stockholm (SE)

(72) Inventors: Alessandra Bigongiari, Pisa (IT); Luigi Tallone, Pisa (IT)

(21) Appl. No.: 18/281,500

(22) PCT Filed: Mar. 11, 2021
(86) PCT No.: PCT/EP2021/056252

§ 371 Date: Sep. 11, 2023

(51) Int. Cl. G02B 6/12; G02B 6/124

(52) U.S. Cl. CPC G02B 6/12014; G02B 6/12002; G02B 6/124; G02B 2006/12038; G02B 2006/12061; G02B 2006/1215

(57) ABSTRACT

An optical bandsplitter (100) comprising: a substrate structure (102), a first waveguide (110) and a second waveguide (130). The first waveguide (110) comprising a first end section (112), a second end section (114) and a first grating section (116) between the first and second end sections. The second waveguide (130) provided adjacent at least one surface of the first waveguide. The first grating section comprising a first grating structure having a grating period, Λ, configured to cause the first grating structure to couple light (152) at wavelengths within a spectral range between the first grating section and the second waveguide.

### TECHNICAL FIELD

The invention relates to an optical bandsplitter. The invention further relates to an optical device and to an optical transceiver.

### BACKGROUND

In wavelength division networking, WDM, network scenarios, optical transceivers, TRX, are required to have bidirectional operation in which a first sub-range of wavelengths are used for uplink, UL, transmission and a second sub-range of wavelengths for downlink, DL, transmission. The subdivision of the WDM operating range into UL and DL subranges is generally performed by an optical bandsplitter. Ideally the bandsplitter should operate over the whole WDM range, for example, the entire telecommunications C-band with a small guard-band, that may correspond to 4-5 ITU-T channels with a spacing of 100 GHz, between the sub-rages.

More generally optical bandsplitters are used to subdivide a large spectral range into smaller sub-ranges that relax the requirements on optical filters or arrayed waveguide, gratings, AWG, by reducing the spectral range that is managed by a single element performing wavelength selection. Bandsplitters are necessary, for example, in a scenario where a tunable optical filter is employed in a WDM network with a large number of channels, since commercial tunable filters at present are only capable to operate on a maximum of 4 bidirectional channels.

There are known solutions for Course WDM, CWDM, optical bandsplitters based on a thin film filter platform, such as the Lumentum® ITU bandsplitters with 100 GHz channel spacing described at https://resource.lumentum.com/s3fs-public/technical-library-items/bandsplitter100_ds_cc_ae.pdf

However, the thin film filter platform is not suitable for photonic integration; thin film filters cannot be integrated in Silicon Photonics circuits containing tunable filters, with standard CMOS compatible processes. As a result, the cost of fabricating thin film filters is generally too high for large scale application in 5G access networks and data centres.

### SUMMARY

It is an object to provide an improved optical bandsplitter. It is a further object to provide an improved optical device. It is a further object to provide an improved optical transceiver.

An aspect of the invention provides an optical bandsplitter comprising a substrate structure, a first waveguide provided on the substrate structure and a second waveguide provided adjacent at least one surface of the first waveguide. The first waveguide comprises a first end section, a second end section and a first grating section between the first and second end sections. The first grating section comprises a first grating structure having a grating period, Λ, configured to cause the first grating structure to couple light at wavelengths within a spectral range between the first grating section and the second waveguide.

The optical bandsplitter is a photonic integrated bandsplitter capable of splitting a WDM bandwidth into two smaller sub-bands. The structure of the optical bandsplitter makes it suitable for integration within a photonic chip, thereby reducing the tolerances required for its fabrication to a manageable precision and complexity. The grating structure and waveguides are suitable to be fabricated with standard lithographic techniques, so that the optical bandsplitter can be fabricated with other photonic integrated components with standard tolerances. The photonic integrated structure of the optical bandsplitter may enable the fabrication of the optical bandsplitter in volumes with a technology that will reduce the cost of the transceiver down to a value that is suitable for large scale application.

The band splitting function is based a periodic grating that couples to light in the spectral range corresponding to a selected sub-band, routes it from the first waveguide to the second waveguide and leaves light at wavelengths in the unselected sub-band to be output from the first waveguide.

In an embodiment, the optical bandsplitter further comprises a third waveguide provided on the substrate structure. The third waveguide comprises a second grating section and a third end section at one end of the second grating section. The second waveguide is provided adjacent at least one surface of the third waveguide, the second waveguide extending in length at least from the first grating section to the second grating section. The second grating section comprising a second grating structure having the grating period, Λ, configured to cause the second grating structure to couple light at wavelengths within the spectral range between the second grating section and the second waveguide.

The band splitting function is based on first and second periodic gratings that couple to light in the spectral range corresponding to a selected sub-band, routes it from the first waveguide to the second waveguide and then into the third waveguide to be output, and leaves light at wavelengths in the unselected sub-band to be output from the first waveguide. The optical bandsplitter advantageously enables spatial separation of spectral sub-bands, such as WDM UL and DL channel sub-bands.

In an embodiment said grating section has a first effective refractive index, n_{eff1}, and a first propagation constant, β₁. The second waveguide has a second effective refractive index, n_{eff2}, different to the first effective refractive index, and a second propagation constant, β₂, different to the first propagation constant, β₁. The grating period, Λ, meets the Bragg condition β₁−β₂=2π/Λ

The grating period meeting the Bragg condition ensures coupling between the guided modes in the two waveguides, with momentum conservation in the transition between the two guided modes.

In an embodiment, the spectral range includes a plurality of channels of a wavelength division multiplexing channel frequency grid. The optical bandsplitter may advantageously be used to separate UL and DL channels within a WDM channel grid.

In an embodiment, the grating period is chirped. The chirp in the periodicity of the grating structure induces a wavelength-dependent coupling condition that gives the spectral response of the optical bandsplitter the necessary shape to obtain the desired band split function. The chirp modifies gradually the wavelength value that meets the Bragg coupling condition meaning guided modes at different wavelengths are coupled to the grating structure as the grating period changes.

In an embodiment, the grating structures have a spectral response flatness equivalent to not more than a 1 dB transmission impairment and at least 20 dB isolation with respect to wavelengths outside the spectral range. The optical bandsplitter is therefore compatible with the flatness and channel isolation requirements of WDM transmission systems.

In an embodiment, the first and third waveguides comprise cores of a core material. The grating structures comprise a series of protrusions of the core material extending from at least one surface of the core of the respective grating section, the protrusions spaced by the grating period. The core and protrusions may advantageously be fabricated using known lithographic, photo-inscription or ion-exchange processes.

In an embodiment, the first and third waveguides comprise a core of a core material and cladding of a cladding material. The grating structures comprise a periodic refractive index variation within at least one of the core material or the cladding material of the respective grating section. The periodic refractive index variation may advantageously be fabricated using known photo-inscription or ion exchange processes that enable the refractive index of an area of material to be increased with respect to the surrounding area of material.

In an embodiment, the grating structures have a modulation depth, D. The modulation depth progressively increases and then progressively decreases along a length of the respective grating structure. This advantageously gradually adapts the mode field and avoids the formation of side-lobes in the selected sub-band.

In an embodiment, the modulation depth, D, progressively increases and then progressively decreases according to a function that is continuously derivable and maintains the first effective refractive index, n_{eff1}, along the length of the respective grating section. This advantageously gradually adapts the mode field and avoids the formation of side-lobes in the spectrum of the selected sub-band.

In an embodiment, the modulation depth, D, varies according to a fourth-order polynomial. This advantageously gradually adapts the mode field and avoids the formation of side-lobes in the selected sub-band.

In an embodiment, said grating section has a width that is greater than a width of a respective end section. A tapered section is provided between the grating section and a respective end section, the tapered section having a width that varies from the width of the end section to the width of the grating section. Using an increased width for the grating section may improve the accuracy of fabrication of the grating protrusions or refractive index variation. The tapered section may adapt the mode field distribution from that of an end section to that of the grating section.

In an embodiment, the width of the tapered section varies adiabatically and one of linearly, polynomially or exponentially. This may smoothly adapt the mode field distribution.

In an embodiment, the first and third waveguides comprise cores of Silica, Si, or Silicon nitride, SiN. The second waveguide comprises a core of doped Silica-dioxide.

In an embodiment, the doped Silica-dioxide is Silica-dioxide doped with Germania.

In an embodiment, the optical bandsplitter is fabricated in a complementary metal oxide semiconductor, CMOS, process. The optical bandsplitter is thus advantageously compatible with standard production lines of CMOS electronics.

Corresponding embodiments and advantages apply to the optical device and optical transceiver described below.

An aspect of the invention provides an optical device comprising a photonic integrated circuit and an optical bandsplitter. The optical bandsplitter comprises a substrate structure, a first waveguide provided on the substrate structure and a second waveguide provided adjacent at least one surface of the first waveguide. The first waveguide comprises a first end section, a second end section and a first grating section between the first and second end sections. The first grating section comprises a first grating structure having a grating period, Λ, configured to cause the first grating structure to couple light at wavelengths within a spectral range between the first grating section and the second waveguide. The second end section is coupled to the photonic integrated circuit for transmission of optical signals between the optical bandsplitter and the photonic integrated circuit.

In an embodiment, the photonic integrated circuit comprises an optical filter configured to transmit a specified wavelength received from one of the second end section or the third end section.

The grating structure and waveguides are suitable to be fabricated with standard lithographic techniques, so that the optical bandsplitter can be fabricated with an integrated optical filter with standard tolerances, to form a tunable optical device.

In an embodiment, the optical device is fabricated in a complementary metal oxide semiconductor, CMOS, process. The optical device is thus advantageously compatible with standard production lines of CMOS electronics, with the advantage of cost reduction from the volume production of a single photonic chip.

An optical transceiver comprising an optical device comprising a photonic integrated circuit and an optical bandsplitter. The optical bandsplitter comprises a substrate structure, a first waveguide provided on the substrate structure and a second waveguide provided adjacent at least one surface of the first waveguide. The first waveguide comprises a first end section, a second end section and a first grating section between the first and second end sections. The first grating section comprises a first grating structure having a grating period, Λ, configured to cause the first grating structure to couple light at wavelengths within a spectral range between the first grating section and the second waveguide. The second end section is coupled to the photonic integrated circuit for transmission of optical signals between the optical bandsplitter and the photonic integrated circuit.

The structure of the optical bandsplitter enables practical realization of an optical transceiver having an integrated photonic structure.

The optical bandsplitter enables spatial separation of WDM UL and DL channels in a silicon photonic circuit chip, reducing the tolerances required for its fabrication to a manageable precision and complexity. This may enable the fabrication of an optical transceiver silicon photonic circuit chip in volumes with a technology that will reduce the cost of the transceiver down to a value that is suitable for large scale deployment.

In an embodiment, the photonic integrated circuit comprises an optical filter configured to transmit a specified wavelength received from one of the second end section or the third end section.

The grating structure and waveguides are suitable to be fabricated with standard lithographic techniques, so that the optical bandsplitter can be fabricated with an integrated optical filter with standard tolerances, enabling a practical realization of a tunable optical transceiver having an integrated photonic structure.

In an embodiment, the optical transceiver is fabricated in a complementary metal oxide semiconductor, CMOS, process. The optical transceiver is thus advantageously compatible with standard production lines of CMOS electronics, with the advantage of cost reduction from the volume production of a single photonic chip.

Embodiments of the invention will now be described, by way of example only, with reference to the accompanying drawings.

### BRIEF DESCRIPTION OF THE DRAWINGS

FIGS. 1 to 4, 10 and 11 are diagrammatic representations of optical bandsplitters according to embodiments;

FIGS. 5 to 9 are diagrammatic representations of grating sections of optical bandsplitters according to embodiments;

FIG. 12 shows an optical spectrum output from the third waveguide;

FIG. 13 shows an optical spectrum output from the first waveguide;

FIG. 14 is a block diagram representing an optical device according to an embodiment; and

FIG. 15 is a block diagram representing an optical transceiver according to an embodiment.

### DETAILED DESCRIPTION

The same reference numbers will be used for corresponding features in different embodiments.

Referring to FIG. 1, an embodiment provides an optical bandsplitter 100 comprising a substrate structure 102, a first waveguide 110 and a second waveguide 130.

The first waveguide 110 is provided on the substrate structure. The second waveguide 130 is provided adjacent at least one surface of the first waveguide, for example on top of an upper (with respect to the substrate structure and as orientated in the Figure) surface of the first waveguide.

The first waveguide comprises a first end section 112, a second end section 114 and a first grating section 116 between the first and second end sections. The first grating section comprises a first grating structure having a grating period, Λ, configured to cause the first grating structure to couple light at wavelengths within a spectral range between the first grating section and the second waveguide.

In use, input light 150 containing a first sub-band 152 and a second sub-band 154 is received at the first end section 112 of the first waveguide 110. The light propagates to the grating section 116 where it interacts with the first grating structure. The grating period of the first grating structure is configured to cause the first grating structure to couple light at wavelengths within the first sub-band 152 from the first grating section into the second waveguide 130. Light at wavelengths within the second sub-band 154 does not interact with the first grating structure and continues to propagate in the first waveguide, through and out of the second end section 114.

In an embodiment, the first grating section 116 has a first effective refractive index, n_{eff1}, and a first propagation constant, β₁. The second waveguide 130 has a second effective refractive index, n_{eff2}, different to the first effective refractive index, and a second propagation constant, β₂, different to the first propagation constant, β₁. The grating period, Λ, of the first grating structure meets the Bragg condition

β₁−β₂=2π/Λ Equation (1)
where

$${β}_{1} = ( \frac{2 π}{λ} ) * {n}_{eff 1}$$

is the propagation constant of the guided mode in the first waveguide and

$${β}_{2} = ( \frac{2 π}{λ} ) * {n}_{eff 2}$$

is the propagation constant of the guided mode in the second waveguide.

The role of the first grating structure is to couple the light propagating in the first waveguide into the second waveguide. The condition for the coupling is given by the Bragg condition of Equation (1). The first grating structure induces coupling between two modes of a waveguide structure (the second waveguide plus the first waveguide). The coupling exploits a small periodic perturbation of the waveguide structure, provided by the first grating structure, that extends longitudinally with a periodicity (the grating period) that fills the gap between the propagation constants of the two modes. This additional periodicity acts as an adaptor, ensuring momentum conservation in the transition between the two field modes.

In an embodiment, the second waveguide also extends down the side surfaces of the first waveguide, towards the substrate structure, so that the second waveguide is provided adjacent to three surfaces of the first waveguide. The first waveguide is therefore effectively provided within the second waveguide, which may improve the coupling effect of the small periodic perturbation of the waveguide structure provided by the first grating structure.

In an embodiment, first and second waveguides have a reverse arrangement, with the second waveguide 130 provided on the substrate structure 102 and the first waveguide 110 formed on top of an upper surface, or within an upper layer, of the second waveguide.

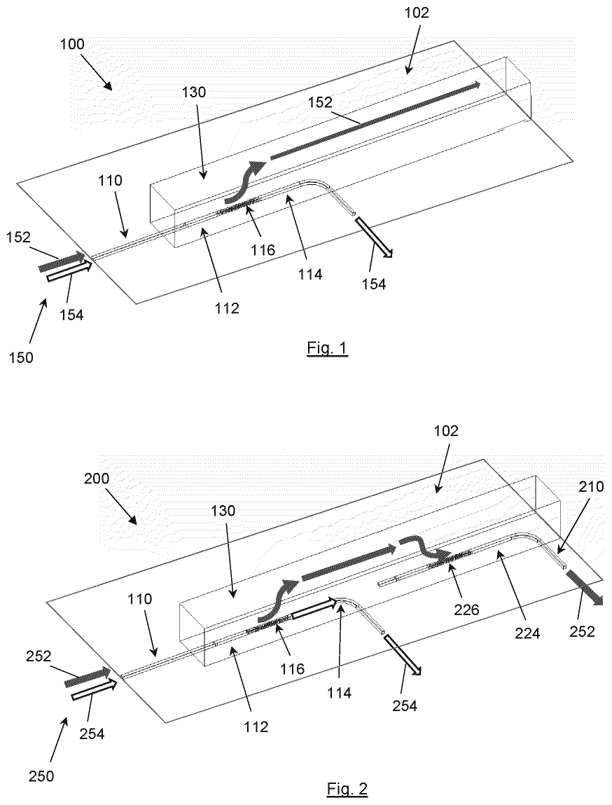

Referring to FIG. 2, an embodiment provides an optical bandsplitter 200 comprising a substrate structure 102, a first waveguide 110, a second waveguide 130 and a third waveguide 210.

The third waveguide comprises a second grating section 226 and a third end section 224 at one end of the second grating section.

The second waveguide 130 is provided adjacent at least one surface of each of the first and third waveguides, for example on top of an upper surface of each waveguide. The second waveguide extends in length at least from the first grating section to the second grating section.

The second grating section comprises a second grating structure having the same grating period, Λ, as the first grating structure, to cause the second grating structure to couple light 212 at wavelengths within the spectral range between the second grating section and the second waveguide.

In use, input light 250 containing a first sub-band 252 and a second sub-band 254 is received at the first end section 112 of the first waveguide 110. The light propagates to the first grating section 116 where it interacts with the first grating structure. The grating period of the first grating structure is configured to cause the first grating structure to couple light at wavelengths within the first sub-band 252 from the first grating section into the second waveguide 130. The light in the first sub-band then propagates in the second waveguide until it reaches an area of the second waveguide adjacent the second grating section 226 in the second waveguide 210, where an evanescent field of the light interacts with the second grating structure causing light in the first sub-band to be coupled into the second grating section. The light in the first sub-band then propagates in the third waveguide 210, through and out of the third end section 224.

Light at wavelengths within the second sub-band 254 does not interact with the first grating structure and continues to propagate in the first waveguide, through and out of the second end section 114.

The second grating section compensates for any chromatic dispersion introduced by the first grating section. The third waveguide allows light at wavelengths within the spectral range of the grating structures to be output from the optical bandsplitter via a waveguide having the same characteristics as the input, i.e. first, waveguide. It is advantageous within an integrated photonic circuit to be able to use the same type of waveguide for both input and output. The second waveguide may be larger than the first waveguide and may not be compatible with the rest of a photonic circuit without a conversion. The second grating section enables this conversion and solves the issue of chromatic dispersion at the same time.

In an embodiment, the first grating section 116 has a first effective refractive index, n_{eff1}, and a first propagation constant, β₁. The second grating section 226 also has the first effective refractive index, n_{eff1}, and the first propagation constant, β₁. The second waveguide 130 has a second effective refractive index, n_{eff2}, different to the first effective refractive index, and a second propagation constant, β₂, different to the first propagation constant, β₁. The grating period, Λ, of each of the first and second grating structures meets the Bragg condition of Equation (1).

Similarly to the first grating structure, the role of the second grating structure is to couple the light propagating in the second waveguide into the third waveguide. The condition for the coupling is given by the Bragg condition of Equation (1). The second grating structure induces coupling between two modes of a waveguide structure (the second waveguide plus the third waveguide). The coupling exploits a small periodic perturbation of the waveguide structure, provided by the second grating structure, that extends longitudinally with a periodicity (the grating period) that fills the gap between the propagation constants of the two modes. This additional periodicity acts as an adaptor, ensuring momentum conservation in the transition between the two field modes.

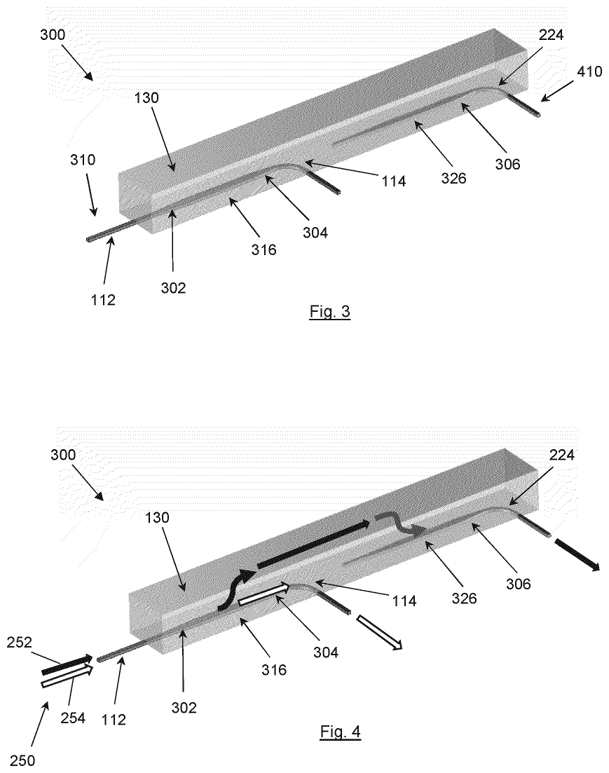

An embodiment provides an optical bandsplitter 300 illustrated in FIGS. 3 and 4. In this embodiment, the first grating section 316 has a width that is greater than the width of the first and second end sections 112, 114, and the second grating section 326 has a width that is greater than the width of the third end section 224. Using a greater width for the grating sections may be desirable for manufacturing reasons, for example to improve the precision with which the grating section may be form using, for example, lithographic deposition.

The first waveguide 310 additionally comprises a first tapered section 302 provided between the first end section 112 and the first grating section 316 and a second tapered section 304 provided between the first grating section and the second end section 114.

The third waveguide 410 additionally comprises a third tapered section 306 provided between the second grating section 326 and the third end section 224.

The first tapered section has a width that varies from the width of the first end section to the width of the first grating section. The second and third tapered sections have widths that vary from the width of the respective grating section to the width of the respective end section.

The first tapered section enables the mode size of the light propagating in the first end section to be gradually adapted to the larger mode size of the first grating region. The second and third tapered sections enable the mode size of the light propagating in the respective grating section to be gradually reduced to the smaller mode size of the respective second or third end section.

For manufacturing simplicity, the first waveguide 310 and the third waveguide 410 may have the same structure, the third waveguide 410 comprising two end sections and two tapered sections.

In an embodiment, the widths of the tapered sections 302, 304, 306 vary adiabatically. This is achieved by the widths of the tapered sections increasing with a linear, polynomial or exponential profile.

In an embodiment, the grating period, Λ, of each of the first and second grating structures is chirped. For example, the grating period may be linearly chirped, meaning that the grating period increases or decreases linearly along the length of the grating structure. The propagation constant, β₁, is wavelength dependent, therefore the wavelength of light that meets the Bragg condition of Equation (1) will vary as the grating period, Λ, varies along the length of the grating structure.

Introducing a linear chirp in the grating period therefore results in a wavelength-dependent coupling condition. The chirp modifies gradually the wavelength value that meets the coupling condition of Equation (1) so that guided modes with different wavelengths can be coupled, within a range that depends on the overall change the grating period. Using a grating structure with a chirped grating period causes a little chromatic dispersion in light within the spectral range of the grating structures, since different spectral components of the input light are coupled between the respective waveguides at different locations of the grating structure, which may result in a small difference in the optical path for each wavelength. This effect is compensated for by the first grating structure and the second grating structure being ‘twin’ gratings, with the same propagation constant, the same spectral range and the same chirp in the direction of propagation of light (for example, left to right in the Figures).

In an embodiment, the grating period is chirped to cause the first and second grating structures to couple light 252 at wavelengths within a spectral range that includes a plurality of channels of a WDM channel frequency grid. For example, 20 channels of the DWDM frequency grid defined in ITU-T standard G.694.1

The optical bandsplitter 300 may therefore be used to split an incoming WDM optical signal into two channel sub-bands and to output the two sub-bands from two physically separate waveguides. The optical bandsplitter 300 may also be used to maintain separation between UL and DL channel bands within a WDM transmission system. For example, the spectral range coupled by the first and second grating structures may correspond to the DL channel band, so that light at UL channel wavelengths is output from the first waveguide 310 and light at DL channel wavelengths is input into the third waveguide 410.

In an embodiment, the grating structures have a spectral response flatness equivalent to not more than a 1 dB transmission impairment and at least 20 dB isolation with respect to wavelengths outside the spectral range. FIG. 12 shows a spectral output from the third waveguide, including the combined spectral response (the wide, flat transmission peak) of the first grating structure and the second grating structure.

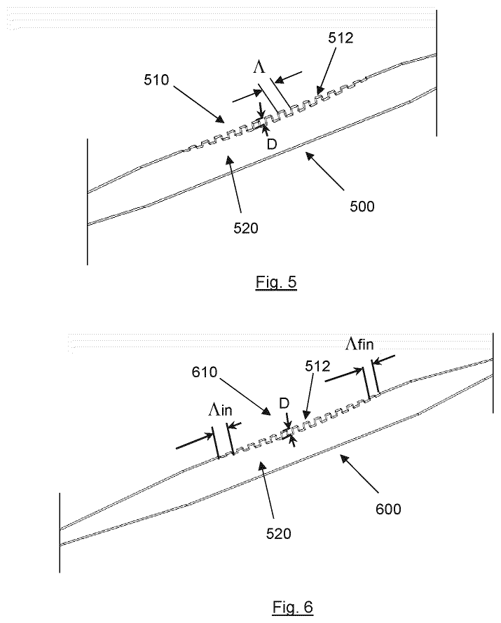

Referring to FIG. 5, in an embodiment, the first and third waveguides 500 comprise respective waveguide cores 520 of a core material, the waveguide cores including the respective grating sections. Each grating section comprises a grating structure 510 comprising a series of protrusions 512 of the core material extending from one side surface of the core of the grating section. The protrusions are spaced by the grating period, A. The grating structure 510 has a modulation depth, D, which progressively increases and then progressively decreases along the length of the grating structure.

Referring to FIG. 6, in an embodiment, the first and third waveguides 600 comprise first and second grating sections each comprising a grating structure 610 having a chirped grating period. The grating period increases linearly from an initial grating period, Λᵢₙ, to a final grating period, Λ_{fin}.

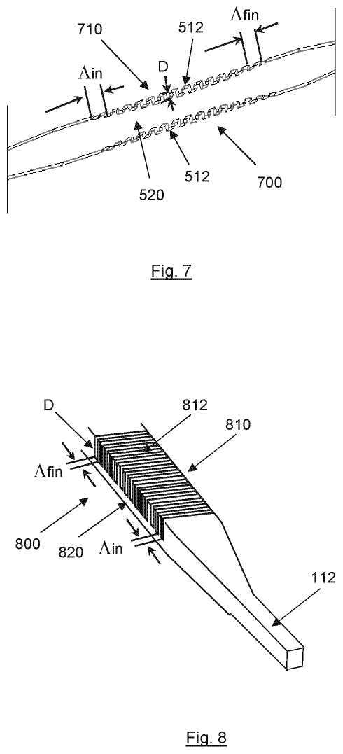

Referring to FIG. 7, in an embodiment, the first and third waveguides 700 comprise first and second grating sections each comprising a grating structure 710. The grating structure comprises two series of protrusions 512 of the core material respectively extending from the side surfaces of the core of the grating section. The protrusions on each side surface are spaced by the grating period, A. The grating period increases linearly from an initial grating period, Λᵢₙ, to a final grating period, Λ_{fin}. The grating structure 710 has a modulation depth, D. The modulation depth is the depth of the protrusions. The modulation depth progressively increases and then progressively decreases along the length of the grating structure 710.

Referring to FIG. 8, in an embodiment, the first and third waveguides 800 comprise waveguide cores 820 of a core material, the waveguide cores including the respective grating sections. Each grating section comprises a grating structure 810 comprising a series of protrusions 812 of the core material extending from the top (relative to the substrate 102 and as orientated in the drawing) surface of the core of the grating section. The protrusions are spaced by the grating period, Λ. The grating period increases linearly from an initial grating period, Λᵢₙ, to a final grating period, Λ_{fin}. The grating structure 810 has a modulation depth, D, which progressively increases and then progressively decreases along the length of the grating structure.

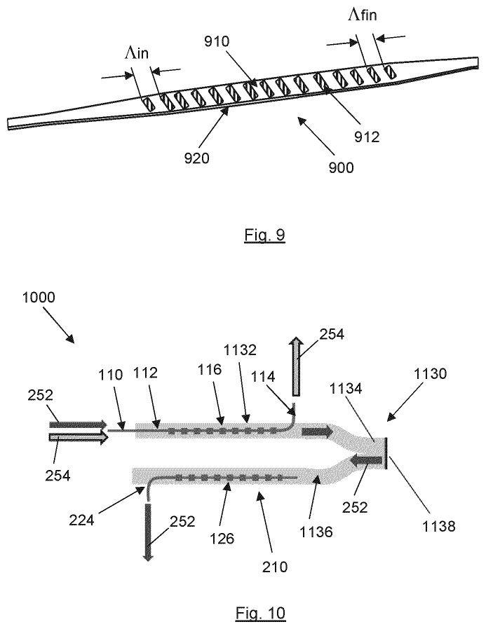

Referring to FIG. 9, in an embodiment the first and third waveguides 900 comprise waveguide cores 820 of a core material and cladding of a cladding material, the waveguide cores including the respective grating sections. Each grating section comprises a grating structure 910 comprising a periodic refractive index variation 912 within the core material of the grating section. The refractive index varies according to the grating, Λ. The grating period increases linearly from an initial grating period, Λᵢₙ, to a final grating period, Λ_{fin}. The grating structure 910 has a modulation depth, D. The modulation depth is the size of the refractive index variation; it is also known as the grating “strength”. The modulation depth progressively increases and then progressively decreases along the length of the grating structure.

The refractive index variation may be obtained via laser irradiation (photo-induced) or via doping (e.g. ion implantation), to periodically increase the refractive index of the core material.

In an embodiment, the refractive index variation is within the cladding material adjacent the core material of the grating section.

In an embodiment, the refractive index variation is within both the core material and the cladding material adjacent the core material of the grating section.

Where refractive index variation is provided within the cladding material, it must be provided close to the waveguide core e.g. within a distance of one wavelength of the light propagating in the waveguide.

In an embodiment, the modulation depth, D, progressively increases and then progressively decreases according to a function that is continuously derivable and maintains the first effective refractive index, n_{eff1}, along the length of the respective grating section.

In an embodiment, the modulation depth, D, varies according to a fourth-order polynomial.

In an embodiment, the first waveguide 110 and the third 210 waveguide each comprise waveguide cores of Silica, Si, or Silicon nitride, SiN. The second waveguide 130 comprises a core of doped Silica-dioxide, for example Silica-dioxide doped with Germania.

The cladding material has a lower refractive index than the waveguide core. For example, the optical bandsplitter may comprise first and third waveguide having a Si or SiN core having a refractive index, n, of 3.5. The substrate 102 may be an insulator substrate with an insulator layer or cladding layer of doped silicon dioxide, SiO₂, (n˜1.45) between the substrate and the core. The cladding may be an air cladding (n=1) silicon dioxide, SiO₂, cladding (n˜1.4) or amorphous oxynitride SiO x N y cladding (n from 1.4 to 2, depending on the proportions, x and y, of O and N).

In an embodiment, the optical bandsplitter is fabricated in a complementary metal oxide semiconductor, CMOS, process.

In an embodiment, referring to FIG. 3, an optical bandsplitter is provided comprising:
An insulator substrate.
Two silicon on insulator, SOI, standard waveguides 310, 410 comprising a Si (or, alternatively, SiN) waveguide core with SiO₂ cladding. Each SOI waveguide comprising:
   two end sections 112, 114, 224 of standard, single mode SOI waveguide size e.g. 450 nm width and 220 nm height.
   a grating section 316, 326 of larger width, e.g. 1.5 μm, with lateral ‘protrusions’ (having a modulation depth of up to 60 nm) forming a chirped periodic grating structure on the walls of the Si waveguide core.
   two tapered sections 302, 304, 306 for each grating section, where the width of the waveguide is increased from the standard width to the larger width of the grating region and vice-versa from the grating to the regular region
A large SiGe doped (for example SiO₂ doped with 2% Ge) waveguide 130 provided on top of the SOI waveguides. Around this SiGe waveguide is a second layer of cladding material, e.g. undoped SiO₂ or other glass, with a refractive index that is lower than the index of the SiGe waveguide.

The SiGe doped waveguide 130 is provided on top of the SOI waveguides 310, 410 in the sense that it is deposited on the SOI waveguides, with no gap in between. The SiGe doped waveguide thus acts as cladding for the SOI waveguides since its refractive index is lower than the Si waveguide core. Outside the SiGe doped waveguide is undoped SiO₂ that acts as cladding for the SiGe doped waveguide since it has a refractive index lower than the SiGe doped waveguide. The SiGe doped waveguide extends into the gaps between the protrusions of the grating structures, whether they are extend from the top surface of the SOI waveguide core or from one or both side surfaces of the SOI waveguide core.

The grating structures are 3.8 mm long and 1.5 μm wide. The grating protrusions have a maximum modulation depth, D, of 60 nm and the grating period is linearly chirped, increasing from an initial grating period, Λᵢₙ, of 1.143 μm to a final grating period, Λ_{fin}, of 1.165 μm, corresponding to a spectral range of 1556 nm to 1573 nm. This means the spectral range of the grating structure covers a 20 nm sub-band (equivalent to 25 ITU-T WDM channels, having a 0.8 nm channel spacing).

The optical bandsplitter can therefore have a footprint that is much smaller than any commercially available optical bandsplitter. The arrangement of the two SOI waveguides and SiGe doped waveguide can be optimized to reduce the length of the optical bandsplitter 300, as described in more detail below with reference to FIGS. 10 and 11.

The grating part of the Si waveguide is enlarged so that the size of the grating protrusions, for example 60 nm, can be accurately achieved using the chosen manufacturing process; for example, 10 nm is considered a good lithography precision. The grating section is characterized by a higher effective refraction index with respect with the end sections (due to the presence of a larger amount of Si as compared to SiO₂), which causes a higher confinement of light. The profile of the mode from the end sections is adapted by increasing the waveguide width adiabatically in the tapered sections where the width of the Si waveguide is increased with a profile that could be linear, polynomial or exponential.

The grating structure is such that a first sub-band of the input spectrum will not match the coupling condition; this sub-band will not coupled to the grating structure and will remain confined in the core of the first Si waveguide. The first Si waveguide is bent after the grating region so that the first sub-band is output at a first spatial location.

The spectral components of the second sub-band instead will match the coupling condition, this radiation will be coupled to the SiGe waveguide and travel along it. Then, the light in the second sub-band is coupled back to a second Si waveguide via a second grating section that has the same coupling condition as the first grating section. After being coupled to the second grating section, the mode size of the second sub-band field is adapted to the mode of the end section of the second Si waveguide and is output at a second spatial location.

The integrated optical bandsplitter is intended to address the issue of separating two spectral components of an input radiation, corresponding to a WDM spectrum in a band of about 40 nm. The target is to obtain two spatially separated sub-bands where each is substantially one half the original spectrum. The bandsplitter is capable of separating the channels of a WDM operational bandwidth of at least 40 nm into two smaller sub bands with a guard band between the sub-bands that is less than 3.2 nm, corresponding to 4 WDM channels.

The integrated band splitter is intended to address the issue of separating two spectral components of an input radiation, corresponding to a WDM spectrum in a band of about 40 nm. The target is to obtain two spatially separated sub-bands where each is substantially to one half the original spectrum. The splitter is designed to have a spectral response such that the impairment between channels in the same sub-band is 1 dB at maximum, which is the flatness requirement of operation in a WDM transmission, and an isolation of at least 20 dB with respect with the adjacent sub-band.

Optical waveguide grating structures can be sensitive to temperature (as the temperature increases the grating period increases, shifting the coupled wavelengths to longer wavelengths). This enables the spectral range of the grating structures 510, 610, 710, 810, 910 to be tuned by heating the grating sections 116, 226, 316, 326, 500, 600, 700, 800, 900 via local heaters and enables the spectral range to be stabilized by temperature stabilization using, for example, a thermo electric cooler, TEC.

FIG. 12 shows a simulated optical spectrum obtained at the output of the second SOI waveguide 410. The spectrum corresponds to the sub-band that has been coupled to the SiGe doped waveguide 130 via the first grating structure of the first grating section 316 and then transferred to the second Si waveguide 410 via the second grating structure of the second grating section 326.

FIG. 13 shows a simulated optical spectrum obtained at the output of the first SOI waveguide 310. The spectrum corresponds second first sub band, i.e. the radiation that has not been coupled into the SiGe doped waveguide 130 via the first grating structure. This is the first sub-band that comprises substantially the spectrum input in the bandsplitter minus the spectrum coupled to the SiGe doped waveguide 130.

The simulation assumes the generic case of a broadband input, in a real application, such as WDM transmission the input may consist in the C-band only.

Referring to FIG. 10, an embodiment provides an optical bandsplitter 1000 in which the first waveguide 110 and the third waveguide 210 are arranged alongside one another on the substrate 102, and the second waveguide 1130 has a folded form, to reduce the footprint of the optical bandsplitter.

The second waveguide comprises a first section 1132 provided on top of the first waveguide, a second section 1136 provided on top of the third waveguide, and semi-directional coupler section (one half of a 0:100 directional coupler) 1136, terminated by a reflector 1138, connecting the first section and the second section. The coupling length of the semi-directional coupler, along which the two sections of the second waveguide are in close proximity, is configured to transfer the totality of the radiation in the first section is transferred into the second section. The reflector 1138 may, for example, comprise a metal layer deposited on the end of the semi-directional coupler section of the second waveguide.

Referring to FIG. 11, an embodiment provides an optical bandsplitter 1100 in which the first waveguide 110 and the third waveguide 210 are arranged alongside one another on the substrate 102, and the second waveguide 1150 has generally u-shaped form, to reduce the footprint of the optical bandsplitter.

The second waveguide 1150 comprises a first section 1152 provided on top of the first waveguide, a second section 1154 provided on top of the third waveguide, and a third section 1156 connecting the first section and the second section. The third section including two reflectors 1158 at the corners. The reflectors are etched mirrors at an angle, for example 45°, with respect to an axis of the second waveguide.

The arrangements of the waveguides in FIGS. 10 and 11 enable the length of the optical bandsplitters 1000, 1100 to be halved compared, for example, to the length of the optical bandsplitter 100. This then enables the design of a photonic chip that is more balanced in width and length dimensions.

One or more of the described embodiments provide an integrated optical bandsplitter capable to route a band of more than 20 nm, that may correspond to a WDM DL or UL sub-band, to first port and the remaining spectrum to a second port, in a way that the isolation with respect with the neighbouring band is at least 20 dB, a value compatible with ITU-T requirement for WDM networks. The optical bandsplitter design allows fabrication with common lithography methods and is compatible with standard C-MOS lines for the production of electronic components, resulting in scalable solution for mass production at a cost that is compatible with the target application. The optical bandsplitter is essential for the feasibility of tunable filters on the same photonic chip with the necessary relaxation on tolerances requirements for the realization of fully tunable transceivers based on this technology.

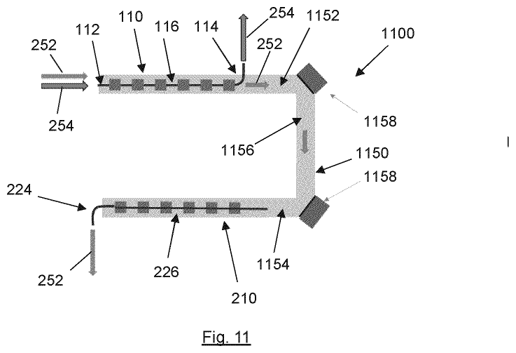

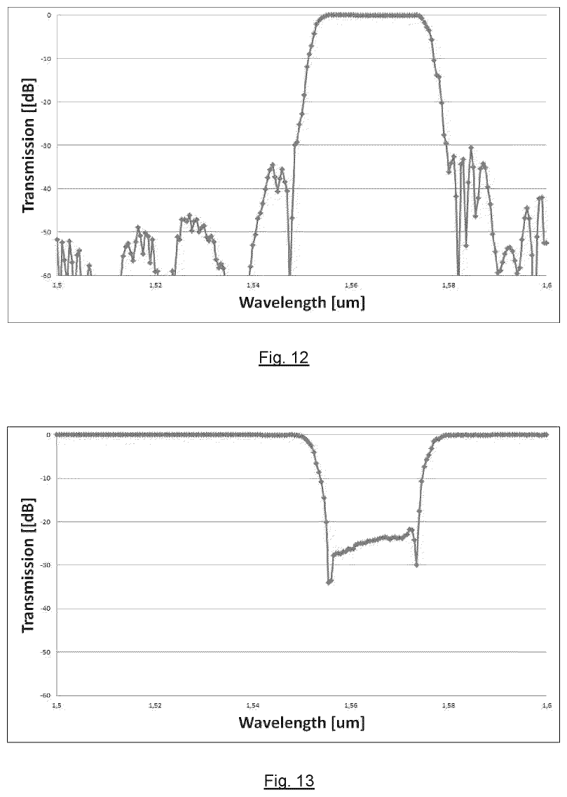

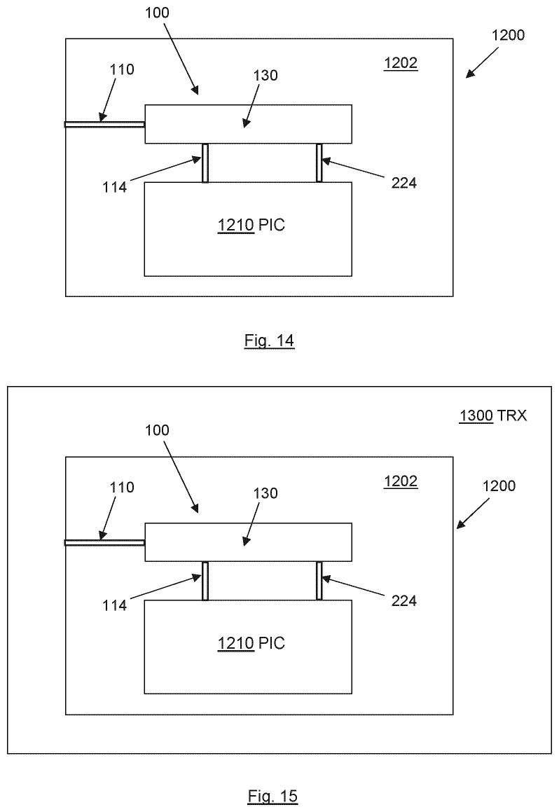

Referring to FIG. 14, an embodiment provides an optical device 1200 comprising a photonic integrated circuit, PIC, 1210 and an optical bandsplitter 200, 300, 1000, 1100, as described above with reference to any of FIGS. 2 to 11. The PIC and the optical bandsplitter are provided on a substrate structure 1202. An optical bandsplitter 100 as described above with reference to FIG. 1 may also be used.

The second end section 114 of the first waveguide is coupled to the PIC for transmission of optical signals outside the spectral range between the optical bandsplitter and the PIC. The third end section 224 of the third waveguide is coupled to the PIC for transmission of optical signals within the spectral range between the optical bandsplitter and the PIC.

In an embodiment, the optical device is fabricated in a CMOS process.

Referring to FIG. 15, an embodiment provides an optical transceiver, TRX, 1300 comprising an optical device 1200 as described above with reference to FIG. 14.

In an embodiment, the optical transceiver is fabricated in a CMOS process.

1. An optical bandsplitter comprising:
a substrate structure;
a first waveguide comprising:
a first end section;
a second end section; and
a first grating section between the first and second end sections; and
a second waveguide provided adjacent at least one surface of the first waveguide; wherein the first grating section comprises a first grating structure having a grating period, L, configured to cause the first grating structure to couple light at wavelengths within a spectral range between the first grating section and the second waveguide.

2. The optical bandsplitter of claim 1, further comprising a third waveguide provided on the substrate structure, the third waveguide comprising:
a second grating section; and
a third end section at one end of the second grating section;
wherein the second waveguide is provided adjacent at least one surface of the third waveguide, the second waveguide extending in length at least from the first grating section to the second grating section, and wherein the second grating section comprises a second grating structure having the grating period, L, configured to cause the second grating structure to couple light at wavelengths within the spectral range between the second grating section and the second waveguide.

3. The optical bandsplitter of claim 1, wherein said first grating section has a first effective refractive index, n_{eff1}, and a first propagation constant, b₁, and the second waveguide has a second effective refractive index, n_{eff2}, different to the first effective refractive index, and a second propagation constant, b₂, different to the first propagation constant, b₁, and wherein the grating period, L, meets the Bragg condition β₁−β₂=2π/Λ.

4. The optical bandsplitter of claim 1, wherein the spectral range includes a plurality of channels of a wavelength division multiplexing channel frequency grid.

5. The optical bandsplitter of claim 1, wherein the grating period is chirped.

6. The optical bandsplitter of claim 1, wherein the grating structures have a spectral response flatness equivalent to not more than a 1 dB transmission impairment and at least 20 dB isolation with respect to wavelengths outside the spectral range.

7. The optical bandsplitter of claim 2, wherein the first and third waveguides comprise cores of a core material and wherein the grating structures comprise a series of protrusions of the core material extending from at least one surface of the core of the respective grating section, the protrusions spaced by the grating period.

8. The optical bandsplitter of claim 2, wherein the first and third waveguides comprise a core of a core material and cladding of a cladding material, and wherein the grating structures comprise a periodic refractive index variation within at least one of the core material or the cladding material of the respective grating section.

9. The optical bandsplitter of claim 7, wherein the grating structures have a modulation depth, D, and wherein the modulation depth progressively increases and then progressively decreases along a length of the respective grating structure.

10. The optical bandsplitter of claim 8, wherein the modulation depth, D, progressively increases and then progressively decreases according to a function that is continuously derivable and maintains the first effective refractive index, n_{eff1}, along the length of the respective grating section.

11. The optical bandsplitter of claim 9, wherein the modulation depth, D, varies according to a fourth-order polynomial.

12. The optical bandsplitter of claim 1, wherein said grating section has a width that is greater than a width of a respective end section; and
wherein a tapered section is provided between said grating section and a respective end section, the tapered section having a width that varies from the width of the end section to the width of the grating section.

13. The optical bandsplitter of claim 12, wherein the width of the tapered section varies adiabatically and one of: linearly, polynomially or exponentially.

14. The optical bandsplitter of claim 2, wherein the first and third waveguides comprise cores of Silica, Si, or Silicon nitride, SiN; and the second waveguide comprises a core of doped Silica-dioxide.

15. The optical bandsplitter of claim 14, wherein the doped Silica-dioxide is Silica-dioxide doped with Germania.

16. The optical bandsplitter of claim 1, wherein the optical bandsplitter is fabricated in a complementary metal oxide semiconductor, CMOS, process.

17. An optical device comprising a photonic integrated circuit and the optical bandsplitter of claim 1, wherein at least one end section is coupled to the photonic integrated circuit for transmission of optical signals between the photonic integrated circuit and the optical bandsplitter.

18. The optical device of claim 17, wherein the photonic integrated circuit comprises an optical filter configured to transmit a specified wavelength output from the optical bandsplitter.

19. The optical device of claim 17 fabricated in a complementary metal oxide semiconductor, CMOS, process.

20. An optical transceiver comprising the optical device of claim 17.
